(19) United States
(12) Patent Application Publication
(10) Pub. No.: US 2009/0312847 A1
(43) Pub. Date: Dec. 17, 2009

(54) TWO SENSOR CONTROL

(76) Inventor: James W. Burrell, IV, Union, NJ (US)

Correspondence Address: Ezra Sutton, P.A.;Suite 201, Plaza 9, 900 Route 9, Woodbridge, NJ, 07095-1024, US

(21) Appl. No.: 12/348,604

(22) Filed: Jan. 5, 2009

Related U.S. Application Data
(63) Continuation-in-part of application No. 10/241,119, filed on Sep. 11, 2002, now Pat. No. 7,160,042.
Application No. 10/241,119 is a continuation-in-part of application No. 11/643,566, filed on Dec. 20, 2006, now abandoned.

(51) Int. Cl. G05B 19/042

(52) U.S. Cl. 700/12

(57) ABSTRACT

This invention relates to methods of using two sensors to control an object. Keyboards use down and up scan codes to produce data. This invention can use either the down or up scan codes to produce functions or shift modes. Using only the down scan codes can be used to edit data, edit changes, change the control of an object, simplify using graphic arts programs or cursor controlled programs, control the state of an object in multiple states or as a method to increase or decrease the state of control of an object. Activating a reprogrammed first sensor produces a secondary first function or the undo function and activating a reprogrammed second sensor produces a secondary second function or the redo function. In another embodiment, activating a first sensor produces a first function and activating a second sensor produces a second function. Activating a first sensor for a duration of time produces a third function and activating a second sensor for a duration of time produces a fourth function. Simultaneously activating a first and second sensor enters a second mode. Activating a first sensor produces a fifth function and activating a second sensor produces a sixth function. Activating a first sensor for a duration of time produces a seventh function and activating a second sensor for a duration of time produces an eighth function. Activating a third sensor or at least one sensor other than a first or second sensor exits a second mode and re-enters a first mode. Simultaneously activating a first and second sensor re-enters a first mode or enters a third mode. While in a third mode, activating a first sensor produces a ninth function and activating a second sensor produces a tenth function. Activating a first sensor for a duration of time produces an eleventh function and activating a second sensor for a duration of time produces a twelfth function. Additionally, a fourth mode, fifth mode, sixth mode, etc. is entered into by simultaneously activating a first and second sensor.

### RELATED APPLICATION

This application is a continuation in part of U.S. Pat. No. 7,160,042 filed Sep. 11, 2002 and abandoned U.S. patent application Ser. No. 11/643,566 filed Dec. 11, 2007.

### FIELD OF THE INVENTION

This invention relates to a method of control using two sensors.

### BACKGROUND OF THE INVENTION

This application is an improvement on the method of sensor control found in U.S. Pat. No. 5,993,089 entitled, “8-BIT BINARY CODE FOR USE AS AN 8-DOT BRAILLE ARRANGEMENT AND DATA ENTRY SYSTEM AND METHOD FOR 8-KEY CHORDIC BINARY KEYBOARDS”, in which a copyright and a patent were granted. In U.S. Pat. No. 7,160,042 filed Sep. 11, 2002 and abandoned U.S. patent application Ser. No. 11/643,566 filed Dec. 11, 2007, the Patent Office failed to examine one part of the taught and claimed invention which embodies the use of a reprogrammed first sensor and a reprogrammed second sensor.

### DESCRIPTION OF PRIOR ART

There are numerous well-known, prior art methods of moving using two sensors independently, the best and oldest examples would be an animal pulled plow and the motor driven tractor. With the rapid development of man-machine interfaces for communication and control, improved methods of movement and control means are becoming increasingly necessary. The main objective of the present invention is to overcome all the deficiencies found in all prior art devices using two sensor control.

### SUMMARY OF THE INVENTION

Briefly described, in one of the preferred embodiments of the present invention uses any two binary sensors or two variable controlled sensors to control the state of an object in a first state by activating a first sensor, control the state of an object in a second state by activating a second sensor, control the state of an object in a third state by activating a first sensor and a second sensor simultaneously and control the state of an object in a fourth state by deactivating and reactivating a first sensor and a second sensor simultaneously. Control of any object, robot, cursor, machine, virtual reality environment, etc. in a one dimensional environment or two dimensional environment can easily be obtained using only two sensors. A computer mouse is one preferred embodiment of the invention. The ability to use a two sensor keyboard to reverse the last change made or to reverse the last undo made while using a pointing device or keyboard in a graphics editing program, will increase the speed and efficiency in any graphics program or any other two axis cursor pointing program. In the applicants issued U.S. Pat. No. 7,160,042, filed Sep. 11, 2002, the Examiner made the applicant amend the end of the independent claims to read “wherein the respective modes are entered or exited based on the activation of only the two respective first and second sensors and no other sensors”. For anyone skilled in the art, when a key or sensor is activated, it sends a down scan code and when it is released, it sends an up scan code. The inclusion of “wherein the respective modes are entered or exited based on the activation of only the two respective first and second sensors and no other sensors” limits the present invention to using both the down and up scan codes for any preferred embodiment. The present invention described in this patent application preferably uses only the down scan codes for enablement.

One preferred embodiment of the present invention allows multiple methods of control using two sensors. Activating a first sensor produces a first preprogrammed function. Activating a second sensor produces a second preprogrammed function. Simultaneously activating the first and second sensor exits the first preprogrammed mode and enters a programmed second mode. Activating the first sensor produces a third programmed function. Activating the second sensor produces a fourth programmed function. Simultaneously activating the first and second sensor exits the programmed second mode and enters a programmed third mode or re-enters the first preprogrammed mode.

In all graphics editing programs, to produce the undo/redo function requires the user to activate two keys simultaneously. The most common two key combinations use activation of the Control key combined with the simultaneous activation of one or more other keys. The standard in almost all computer programs, uses the simultaneous activation of the Control key and the Z key to produce the Undo function and the simultaneous activation of the Control key and the Y key to produce the Redo function. While working in graphics editing programs, many of the keys on a computer keyboard produce no function at all when activated.

Another preferred embodiment of the present invention allows another method of control using only two sensors. Independently activating a first sensor to reverse the last change. Independently activating a second sensor to reverse the last undo.

Another preferred embodiment of the present invention allows another method of control and rate of control using only two sensors. Using any adjustable sensor will increase or decrease the rate of an object by producing different degrees of activation. Activating an adjustable first sensor will control the state of an object. Increasing the activation parameters of an adjustable first sensor will increase the rate of control of an object and decreasing the activation parameters of an adjustable first sensor will decrease the rate of control of an object. Activating an adjustable second sensor will control the state of an object. Increasing the activation parameters of an adjustable second sensor will increase the rate of control of an object and decreasing the activation parameters of an adjustable second sensor will decrease the rate of control of an object.

It is an object of the present invention to provide a method of two sensor control wherein independent activation of two sensors, two unused sensors, two un-programmed sensors or two reprogrammed sensors using the down or active scan codes on a computer keyboard or independent activation of two sensors, two unused sensors, two un-programmed sensors or two reprogrammed sensors using the down or active scan codes on a touch screen keyboard, while in a graphics editing program or in any computer program, use a first sensor to reverse the last change and a second sensor to reverse the last undo.

It is another object of the present invention to provide a method of two sensor control wherein activating a first or a second sensor produces no function. Activating a reprogrammed first sensor produces a reprogrammed first function and activating a reprogrammed second sensor produces a reprogrammed second function.

It is still another object of the present invention to provide a method of two sensor control wherein activating a first or a second sensor produces no function. Activating a reprogrammed first sensor produces a reprogrammed first function and activating a reprogrammed second sensor produces a reprogrammed second function.

It is yet another object of the present invention to provide a method of two sensor control wherein activating a first sensor produces a first function and activating a second sensor produces a second function. Activating a reprogrammed first sensor produces a reprogrammed third function and activating a reprogrammed second sensor produces a reprogrammed fourth function.

It is a further object of the present invention to provide a method of two sensor control wherein activating at least one sensor other than said first or second sensors exits one mode and enters another mode.

It is yet a further object of the present invention to provide a method of two sensor control wherein in any computer program, simultaneously activating the left and right space bar, the cursor left and cursor right sensors or any two sensors exits a first mode and enters a second mode. Simultaneously activating the left and right space bar, the cursor left and cursor right sensors or any two sensors a second time exits a second mode and enters a third mode or re-enters a first mode.

Finally, it is a another object of the present invention to provide a method of two sensor control wherein activating a first sensor, in a preferred first mode, produces a first function and activating a second sensor, in a preferred first mode, produces a second function. Continually activating a first sensor for a pre-programmed duration of time, in a preferred first mode, produces a third function and continually activating a second sensor for a pre-programmed duration of time, in a preferred first mode, produces a fourth function. Simultaneously activating then deactivating a first and second sensor to exit a first mode and to enter a second mode. Activating a first sensor, in a preferred second mode, produces a fifth function and activating a second sensor, in a preferred second mode, produces a sixth function. Continually activating a first sensor for a pre-programmed duration of time, in a preferred second mode, produces a seventh function and continually activating a second sensor for a pre-programmed duration of time, in a preferred second mode, produces an eighth function. Simultaneously activating and deactivating a first and second sensor to exit a second mode and to enter a third mode. Activating a first sensor, in a preferred second mode, produces a ninth function and activating a second sensor, in a preferred second mode, produces a tenth function. Simultaneously activating and deactivating a first and second sensor to exit a second mode and to re-enter a first mode.

The present invention and many preferred embodiments of the present invention all use independent activation and simultaneous activation of two sensors to control an object in multiple modes and at least one sensor, other than said used two sensors, to exit any secondary programmed mode and return to a first preprogrammed mode.

The system and method of the two sensor control invention, according to the preferred embodiments and alternative preferred embodiments of the invention, are logically developed, relatively easy to learn and very quick to use.

These and other objects, features and advantages of the present invention are provided within this patent application and will be more fully understood in connection with the following drawings and descriptions of the preferred embodiments. Additional objects of the present invention will become apparent as the description proceeds.

It is to be understood that the present invention is not limited in its application to the details of construction and to the arrangements of the components set forth in the following description or illustrated in the drawings. The present invention is capable of other embodiments and of being practiced and carried out in various ways. It should be also understood that the phraseology and terminology used in this patent application are for the purpose of describing and claiming the present invention and should not be regarded as limiting.

### DESCRIPTION OF THE DRAWINGS

FIG. 1. Illustrates one preferred horizontal arrangement of a two sensor embodiment found in the disclosed invention.

FIG. 2. Illustrates one preferred vertical arrangement of a two sensor embodiment found in the disclosed invention.

FIG. 3. Illustrates one preferred arrangement of a horizontal first set of two sensors positioned on the bottom and on either side of a vertical second set of two sensors found in the disclosed invention.

### DETAILED DESCRIPTION OF THE PREFERRED EMBODIMENT

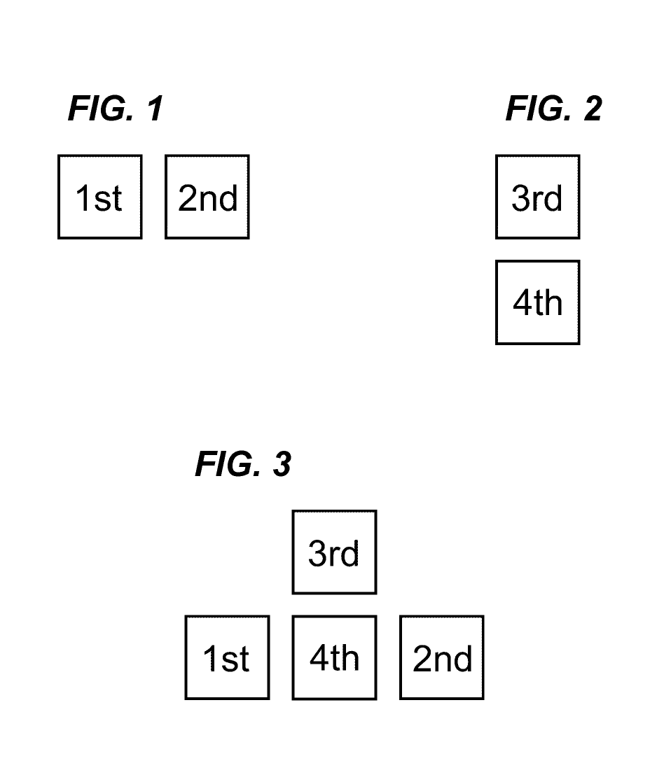

In order to more fully understand the invention, during the course of this description the two sensor invention will be labeled as a first sensor and a second sensor, unless a second set of two sensors is added, and will be used to easily identify like elements according to the different figures which illustrate the invention. The preferred embodiments of the present invention are shown in FIGS. 1, 2 and 3 in the preferred embodiment's simplest binary sensor on/off method form.

One preferred embodiment of the present invention uses any two binary sensors or two variable controlled sensors for control in a first state by activating a first sensor, and in a second state by activating a second sensor. Control of any object, robot, cursor, machine, virtual reality environment, etc. in a one dimensional environment or two dimensional environment can easily be obtained using only two sensors. A computer mouse is one preferred embodiment of the invention. Other examples of two sensor preferred embodiments of the invention are the cursor left and cursor right keys on a standard computer keyboard, the left and right space bar keys on a split space bar computer keyboard, any two keys on a standard computer keyboard, any two keys on any keyboard or data entry device ever produced or will ever be produced. The ability to use a two sensor keyboard to reverse the last change made or to reverse the last undo made while using a pointing device in a graphics program, will increase the speed and efficiency in any graphics program or any other two axis cursor pointing program. Any two binary sensors or two variable controlled sensors includes but is not limited to: accelerometers, biometric sensors, biosensors, flex sensors, micro force sensors, motion sensors, optical sensors, piezoelectric force sensors, position sensors, pressure sensors, temperature sensors, touch sensors, touch screen sensors, contact switch, detector switch, dimmer switch, dual motion switch, electromechanical switch, key switch, membrane switch, pushbutton switch, rocker switch, rotary switch, snap action switch, toggle switch, vertical touch switch, and the like.

In all graphics editing programs, to produce the undo/redo function requires the user to activate two keys simultaneously. The most common two key combinations use activation of the Control key combined with the simultaneous activation of one or more other keys. The standard in almost all computer programs, uses the simultaneous activation of the Control key and the Z key to produce the Undo function and the simultaneous activation of the Control key and the Y key to produce the Redo function. While working in graphics editing programs, many of the keys on a computer keyboard produce no function at all when activated.

Another preferred embodiment of the present invention allows another method of control using only two sensors. Independently activating a first sensor, preferably a left sensor, to reverse the last change. Independently activating a second sensor, preferably a right sensor, to reverse the last undo. Independent activation of any two unused and un-programmed sensors on a computer keyboard or touch screen keyboard, while in a graphics editing program or in any computer program, reprogrammed to use said two reprogrammed sensors to reverse the last change using an unused first sensor and to reverse the last undo using an unused second sensor. The preferred embodiments of the present invention allow a method of control using only two sensors to reverse the last change and reverse the last undo. Independently activating a first sensor, preferably a left spacebar sensor or a cursor left sensor, reverses the last change. Independently activating a second sensor, preferably a right spacebar sensor or a cursor right sensor, reverses the last undo. Alternatively, in any computer program, activating the left and right space bar simultaneously once, twice, three times, etc. can also exit the first programmed spacing mode and enter a second reprogrammed undo/redo mode on the space bar keys or activating the cursor left and cursor right movement keys simultaneously can also exit the cursor movement mode and enter a second reprogrammed undo/redo mode on the cursor movement keys. Simultaneous activation of any two keys on a computer keyboard can exit a first programmed mode and enter a second mode to produce secondary functions when using any computer program.

One object of the present invention uses two sensors to control an object wherein activating a first sensor produces a first reprogrammed secondary function and activating a second sensor produces a second reprogrammed secondary function.

It is still another object of the present invention uses two sensors to control an object wherein independently activating a first sensor, preferably a left sensor, to reverse the last change or entry. Independently activating a second sensor, preferably a right sensor, to reverse the last undo deletion.

Independent activation of any two used, unused and un-programmed sensors on a computer keyboard or touch screen keyboard, while in a graphics editing program or in any computer program, is reprogrammed to use two reprogrammed sensors to reverse the last change or entry using an unused first sensor and to reverse the last undo using an unused second sensor.

Preferred embodiments of the present invention allow a method of control using only two sensors to reverse the last change and reverse the last undo in an undo/redo mode. Independently activating a first sensor, preferably a left spacebar sensor or a cursor left sensor, reverses the last change. Independently activating a second sensor, preferably a right spacebar sensor or a cursor right sensor, reverses the last undo.

Alternatively, in any computer program, activating the left and right space bar simultaneously once, twice, three times, etc. can also exit the first programmed spacing mode and enter a first, second, third, etc. reprogrammed mode or undo/redo mode on the left and right space bar sensors, the cursor left and cursor right movement sensors or any two sensors on a keyboard or data entry device.

Simultaneously activating the first preferred cursor left sensor and the second preferred cursor right sensor exits the first cursor movement mode and enters a second reprogrammed undo/redo mode on the left and right cursor movement sensors or on any two programmed or reprogrammed keys or sensors.

Simultaneous activation of any two sensors on a computer keyboard exits a first programmed mode on said same two sensors and enters a second programmed or reprogrammed mode to produce secondary functions on said same two sensors when using any computer program.

Another embodiment of the present invention uses two sensors to control an object wherein activating a first sensor, in a preferred first mode, produces no function at all and activating a second sensor, in a preferred first mode, produces no function at all. Activating a reprogrammed first sensor, in a preferred first mode, produces a reprogrammed first function and activating a reprogrammed second sensor, in a preferred first mode, produces a reprogrammed second function.

Another embodiment of the present invention uses two sensors to control an object wherein activating a first sensor, in a preferred first mode, produces no function at all and activating a second sensor, in a preferred first mode, produces no function at all. Activating a reprogrammed first sensor, in a preferred second mode, produces a reprogrammed first function and activating a reprogrammed second sensor, in a preferred second mode, produces a reprogrammed second function.

Another embodiment of the present invention uses two sensors to control an object wherein activating a first sensor, in a preferred first mode, produces no function at all and activating a second sensor, in a preferred first mode, produces no function at all. Activating at least one sensor other than said first or second sensors exits a first mode and enters a second mode. Activating a reprogrammed first sensor, in a preferred second mode, produces a reprogrammed first function and activating a reprogrammed second sensor, in a preferred second mode, produces a reprogrammed second function.

Another embodiment of the present invention uses two sensors to control an object wherein activating a first sensor, in a preferred first mode, produces a first function and activating a second sensor, in a preferred first mode, produces a second function. Activating at least one sensor other than said first or second sensors exits a first mode and enters a second mode. Activating a reprogrammed first sensor, in a preferred second mode, produces a reprogrammed third function and activating a reprogrammed second sensor, in a preferred second mode, produces a reprogrammed fourth function.

Another embodiment of the present invention uses two sensors to control an object wherein activating a first sensor, in a preferred first mode, produces a preprogrammed first function and activating a second sensor, in a preferred first mode, produces a preprogrammed second function. Activating at least one sensor other than said first or second sensors exits a first mode and enters a second mode. Activating a reprogrammed first sensor, in a preferred second mode, produces a reprogrammed third function and activating a reprogrammed second sensor, in a preferred second mode, produces a reprogrammed fourth function.

Another embodiment of the present invention uses two sensors to control an object wherein activating a reprogrammed first sensor, in a preferred second mode, produces a reprogrammed first function and activating a reprogrammed second sensor, in a preferred second mode, produces a reprogrammed second function.

Another embodiment of the present invention uses two sensors to control an object wherein activating a reprogrammed first sensor, using a computer program, produces an undo function and activating a reprogrammed second sensor, using a computer program, produces a redo function.

Another object of the present invention uses two sensors to control an wherein activating a first sensor, in a preferred first mode, produces a first function and activating a second sensor, in a preferred first mode, produces a second function. Simultaneously activating then deactivating a first and second sensor exits a first mode and enters a second mode. Activating a first sensor, in a preferred second mode, produces a third function and activating a second sensor, in a preferred second mode, produces a fourth function.

Another embodiment of the present invention uses two sensors to control an object wherein activating a first sensor, in a preferred first mode, produces a first function and activating a second sensor, in a preferred first mode, produces a second function. Continually activating a first sensor for a pre-programmed duration of time, in a preferred first mode, produces a third function and continually activating a second sensor for a pre-programmed duration of time, in a preferred first mode, produces a fourth function. Simultaneously activating then deactivating a first and second sensor exits a first mode and enters a second mode. Activating a first sensor, in a preferred second mode, produces a fifth function and activating a second sensor, in a preferred second mode, produces a sixth function. Continually activating a first sensor for a pre-programmed duration of time, in a preferred second mode, produces a seventh function and continually activating a second sensor for a pre-programmed duration of time, in a preferred second mode, produces an eighth function.

Another embodiment of the present invention uses two sensors to control an object wherein simultaneously activating and deactivating a first and second sensor exits a second mode and re-enters a first mode.

Another embodiment of the present invention uses two sensors to control an object wherein the step of activating and deactivating a third sensor exits a second mode and re-enters a first mode.

Another embodiment of the present invention uses two sensors to control an object wherein the step of activating and deactivating at least one sensor other than a first or second sensor exits a second mode and re-enters a first mode.

Another embodiment of the present invention uses two sensors to control an object wherein the step of simultaneously activating and deactivating a first and second sensor exits a second mode and enters a third mode.

Another embodiment of the present invention uses two sensors to control an object wherein the step of simultaneously activating and deactivating a first and second sensor exits a third mode and re-enters a first mode.

Another embodiment of the present invention uses two sensors to control an object wherein the step of activating and deactivating a third sensor exits a third mode and re-enters a first mode.

Another embodiment of the present invention uses two sensors to control an object wherein the step of activating and deactivating at least one sensor other than a first or second sensor exits a third mode and re-enters a first mode.

Another embodiment of the present invention uses two sensors to control an object wherein activating a first sensor, in a preferred first mode, produces a first function and activating a second sensor, in a preferred first mode, produces a second function. Continually activating a first sensor for a pre-programmed duration of time, in a preferred first mode, produces a third function and continually activating a second sensor for a pre-programmed duration of time, in a preferred first mode, produces a fourth function. Simultaneously activating then deactivating a first and second sensor exits a first mode and enters a second mode. Activating a first sensor, in a preferred second mode, produces a fifth function and activating a second sensor, in a preferred second mode, produces a sixth function. Continually activating a first sensor for a pre-programmed duration of time, in a preferred second mode, produces a seventh function and continually activating a second sensor for a pre-programmed duration of time, in a preferred second mode, produces an eighth function.

Another embodiment of the present invention uses two sensors to control an object wherein simultaneously activating and deactivating a first and second sensor exits a second mode and enters a third mode. Activating a first sensor, in a preferred second mode, produces a ninth function and activating a second sensor, in a preferred second mode, produces a tenth function. Simultaneously activating and deactivating a first and second sensor exits a second mode and re-enters a first mode.

Another embodiment of the present invention uses two sensors to control an object wherein simultaneously activating and deactivating a first and second sensor exits a second mode and enters a third mode. Activating a first sensor, in a preferred second mode, produces a ninth function and activating a second sensor, in a preferred second mode, produces a tenth function. Activating and deactivating at least one sensor other than a first or second sensor exits a second mode and re-enters a first mode or activating and deactivating a third sensor exits a second mode and re-enters a first mode.

The scope of the previously disclosed embodiments of the present invention all preferably include the steps of activating a first sensor to produce a first function and activating a second sensor to produce a second function. Simultaneously activating and deactivating a first and a second sensor exits a first programmed mode and enters a second preprogrammed mode, wherein activating a first sensor produces a third function and activating a second sensor produces a fourth function. Simultaneously activating and deactivating a first and a second sensor exits the second mode and enters into a third mode or re-enters the first mode, wherein activating a first sensor produces a fifth function or the first function in the re-entered first mode and activating a second sensor produces a sixth function or the second function in the re-entered first mode. Activation of any third sensor on the computer keyboard to produce the sensor's preprogrammed letter, number, punctuation mark, symbol, character, function, control, etc., while in a preferred second mode, third mode etc. allows the first and second sensors to exit the second mode, third mode etc. or allows the first and second sensors to remain in the second mode, third mode etc.

Alternatively, another embodiment of the present invention includes activating a first sensor to produce a first function and activating a second sensor to produce a second function. Simultaneously activating a first and a second sensor exits a first preprogrammed mode and enters into a second mode, wherein deactivating a second sensor while continuing to activate a first sensor produces a third function and deactivating the first sensor enters into a second mode or re-enters the first mode. In the second mode the first sensor produces a third function and in the first mode the first sensor produces a first function. Simultaneously activating a first and a second sensor exits a first preprogrammed mode and enters into a second mode, wherein deactivating a first sensor while continuing to activate a second sensor produces a fourth function and deactivating the second sensor enters into a second mode or re-enters the first mode. In the second mode the second sensor produces a fourth function and in the first mode the second sensor produces a second function.

A further embodiment of the present invention includes simultaneously activating a first and a second sensor exits a second mode and enters into a third mode or re-enters the first mode, wherein deactivating a second sensor while continuing to activate a first sensor produces a fifth function or the first function in the re-entered first mode and deactivating the first sensor enters into a third mode or re-enters the first mode. In the third mode the first sensor produces a fifth function and in the first mode the first sensor produces a first function. Simultaneously activating a first and a second sensor exits a second mode and enters into a third mode or re-enters the first mode, wherein deactivating a first sensor while continuing to activate a second sensor produces a sixth function or the second function in the re-entered first mode and deactivating the second sensor enters into a third mode or re-enters the first mode. In the third mode the second sensor produces a sixth function and in the first mode the second sensor produces a second function.

Activation of a third sensor or at least one sensor other than the first and second sensor on the computer keyboard to produce the sensor's preprogrammed letter, number, punctuation mark, symbol, character, function, control, etc., while in a preferred second mode, third mode etc. allows the first and second sensors to exit the second mode, third mode etc. or allow the first and second sensors to remain in the second mode, third mode etc.

These and other features of the present invention will be more fully understood by referencing the drawings and the description of the invention described in this patent disclosure.

In summary, the two sensor control invention, according to the preferred embodiment and alternative preferred embodiments of the invention, is logically developed, relatively easy to learn and very quick to use.

While the present invention disclosed has been described with reference to the preferred embodiments thereof, a latitude of modification, change, and substitution is intended in the foregoing disclosure, and in some instances, some features of the invention will be employed without a corresponding use of the inventions other features. Accordingly, it will be appreciated by those having an ordinary skill in the art that various modifications can be made to the system of the invention and it is appropriate that the description and appended claims are construed broadly and in a manner consistent with the spirit and scope of the invention herein without departing from the spirit and scope of the invention as a whole.

1. A method of using two sensors to control an object comprising the steps of:
a) activating a first sensor to produce a first reprogrammed secondary function; and
b) activating a second sensor to produce a second reprogrammed secondary function.

2. A method of using two sensors to control an object, in accordance with claim 1, comprising the steps of:
a) activating said first sensor, in a first mode, to produce no function;
b) activating said second sensor, in said first mode, to produce no function;
c) activating a reprogrammed said first sensor, in said first mode, to produce a reprogrammed first function; and
d) activating a reprogrammed said second sensor, in said first mode, to produce a reprogrammed second function.

3. A method of using two sensors to control an object, in accordance with claim 1, comprising the steps of:
a) activating said first sensor, in a first mode, to produce no function;
b) activating said second sensor, in said first mode, to produce no function;
c) activating a reprogrammed said first sensor, in a second mode, to produce a reprogrammed first function; and
d) activating a reprogrammed said second sensor, in said second mode, to produce a reprogrammed second function.

4. A method of using two sensors to control an object, in accordance with claim 1, comprising the steps of:
a) activating said first sensor, in said first mode, to produce no function;
b) activating said second sensor, in said first mode, to produce no function;
c) activating at least one sensor enters a second mode;
d) activating a reprogrammed said first sensor, in said second mode, to produce a reprogrammed first function; and
e) activating a reprogrammed said second sensor, in said second mode, to produce a reprogrammed second function.

5. A method of using two sensors to control an object, in accordance with claim 1, comprising the steps of:
a) activating said first sensor, in said first mode, to produce a first function;
b) activating said second sensor, in said first mode, to produce a second function;
c) activating at least one sensor enters a second mode;
d) activating a reprogrammed said first sensor, in said second mode, to produce a reprogrammed third function; and
e) activating a reprogrammed said second sensor, in said second mode, to produce a reprogrammed fourth function.

6. A method of using two sensors to control an object, in accordance with claim 1, comprising the steps of:
a) activating said first sensor, in said first mode, to produce a preprogrammed first function;
b) activating said second sensor, in said first mode, to produce a preprogrammed second function;
c) activating at least one sensor enters a second mode;
d) activating a reprogrammed said first sensor, in said second mode, to produce a reprogrammed third function; and
e) activating a reprogrammed said second sensor, in said second mode, to produce a reprogrammed fourth function.

7. A method of using two sensors to control an object, in accordance with claim 1, comprising the steps of:
a) activating a reprogrammed said first sensor, in a second mode, to produce a reprogrammed first function; and
b) activating a reprogrammed said second sensor, in said second mode, to produce a reprogrammed second function.

8. A method of using two sensors to control an object, in accordance with claim 1, comprising the steps of:
a) activating a reprogrammed said first sensor, using a computer program, to produce an undo function; and
b) activating a reprogrammed said second sensor, using said computer program, to produce a redo function.

9. A method of using two sensors to control an object comprising the steps of:
a) activating a first sensor, in a first mode, to produce a first function; and
b) activating a second sensor, in said first mode, to produce a second function;
c) simultaneously activating then deactivating said first sensor and said second sensor exits said first mode and enters a second mode;
e) activating said first sensor, in said second mode, to produce a third function; and
f) activating said second sensor, in said second mode, to produce a fourth function.

10. A method of using two sensors to control an object, in accordance with claim 9, further comprising the steps of:
a) activating a first sensor, in said first mode, to produce a first function;
b) activating a second sensor, in said first mode, to produce a second function;
c) continually activating said first sensor for a pre-programmed duration of time, in said first mode, to produce a third function;
d) continually activating said second sensor for a pre-programmed duration of time, in said first mode, to produce a fourth function;
e) simultaneously activating then deactivating said first sensor and said second sensor exits said first mode and enters a second mode;
f) activating said first sensor, in said second mode, to produce a fifth function;
g) activating said second sensor, in said second mode, to produce a sixth function;
h) continually activating said first sensor for a pre-programmed duration of time, in said second mode, to produce a seventh function; and
i) continually activating said second sensor for a pre-programmed duration of time, in said second mode, to produce an eighth function.

11. A method of using two sensors to control an object, in accordance with claim 9, further comprising the step of simultaneously activating and deactivating said first sensor and said second sensor exits said second mode and re-enters said first mode.

12. A method of using two sensors to control an object, in accordance with claim 9, further comprising the step of activating and deactivating a third sensor exits said second mode and re-enters said first mode.

13. A method of using two sensors to control an object, in accordance with claim 9, further comprising the step of activating and deactivating at least one sensor other than said first sensor or said second sensor exits said second mode and re-enters said first mode.

14. A method of using two sensors to control an object, in accordance with claim 9, further comprising the step of simultaneously activating and deactivating said first sensor and said second sensor exits said second mode and enters a third mode.

15. A method of using two sensors to control an object, in accordance with claim 14, further comprising the step of simultaneously activating and deactivating said first sensor and said second sensor exits said third mode and re-enters said first mode.

16. A method of using two sensors to control an object, in accordance with claim 14, further comprising the step of activating and deactivating a third sensor exits said third mode and re-enters said first mode.

17. A method of using two sensors to control an object, in accordance with claim 14, further comprising the step of activating and deactivating at least one sensor other than said first sensor or said second sensor exits said third mode and re-enters said first mode.

18. A method of using two sensors to control an object comprising the steps of:
a) activating a first sensor, in said first mode, to produce a first function;
b) activating a second sensor, in said first mode, to produce a second function;
c) continually activating said first sensor for a pre-programmed duration of time, in said first mode, to produce a third function;
d) continually activating said second sensor for a pre-programmed duration of time, in said first mode, to produce a fourth function;
e) simultaneously activating then deactivating said first sensor and said second sensor exits said first mode and enters a second mode;
f) activating said first sensor, in said second mode, to produce a fifth function;
g) activating said second sensor, in said second mode, to produce a sixth function;
h) continually activating said first sensor for a pre-programmed duration of time, in said second mode, to produce a seventh function; and
i) continually activating said second sensor for a pre-programmed duration of time, in said second mode, to produce an eighth function.

19. A method of using two sensors to control an object, in accordance with claim 18, further comprising the steps of:
a) simultaneously activating and deactivating said first sensor and said second sensor exits said second mode and enters a third mode.
b) activating said first sensor, in said second mode, to produce a ninth function;
c) activating said second sensor, in said second mode, to produce a tenth function; and
d) simultaneously activating and deactivating said first sensor and said second sensor exits said second mode and re-enters a first mode.

20. A method of using two sensors to control an object, in accordance with claim 18, further comprising the steps of:
a) simultaneously activating and deactivating said first sensor and said second sensor exits said second mode and enters a third mode.
b) activating said first sensor, in said second mode, to produce a ninth function;
c) activating said second sensor, in said second mode, to produce a tenth function;
d) activating and deactivating at least one sensor other than said first or said second sensor exits said second mode and re-enters said first mode; or
e) activating and deactivating a third sensor exits said second mode and re-enters said first mode.
